(19) United States
(12) Patent Application Publication
(10) Pub. No.: US 2018/0374041 A1
(43) Pub. Date: Dec. 27, 2018

(54) Intermodal Network Terminal Operating Process

(71) Applicant: Eugene J. Bambach, Lockport, IL (US)

(72) Inventor: Eugene J. Bambach, Lockport, IL (US)

(21) Appl. No.: 16/013,865

(22) Filed: Jun. 20, 2018

Related U.S. Application Data
(60) Provisional application No. 62/522,991, filed on Jun. 21, 2017.

(51) Int. Cl. G06Q 10/08

(52) U.S. Cl. CPC G06Q 10/0835

(57) ABSTRACT

This invention relates to a process that will eliminate the impact caused by the wasteful handling of intermodal chassis by a terminal operator and provides an efficient, robust intermodal network in order to maximize and streamline motor carrier time in the shipping yard and results in increased profitability systemwide. This is the first step to a fully-integrated, healthy, viable Intermodal Network.

### CROSS-REFERENCE TO RELATED APPLICATIONS

This Application claims priority to previously-filed US Provisional Utility Application No. 62522991, filed on 21 Jun. 2017 entitled Improvement to Intermodal Network Terminal Operating Process.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LIST COMPACT DISC APPENDIX

Not applicable.

### BACKGROUND OF THE INVENTION

For those on the front battle line of Intermodal, it is known that the outputs of everyone's efforts to move current volumes of containerized freight is fragmented, inefficient and unharmonious. Each component involved of the intermodal terminal process—Motor Carrier, Equipment Provider, Terminal Operator, Repair Vendor, Shipper/BCO, and Railroad—has its own individual method, routine, and protocol. Therefore, the process is fragmented, inefficient and unharmonious. What intermodal lacks is an integrated, streamlined process to guide each operating group and unify each with the others.

Intermodal terminals are clearly choke points or bottlenecks to the network, eventually causing starts and stops, ebbs and flows and then tidal wave surges of containerized freight that cannot be digested inland nor at the ports. This easily brings the Intermodal Network to its knees. The entire flow of containerized freight is limited not to flatcar capacity and utilization, train speeds, etc., rather it is more dependent to the size of the bottle necks at the terminals.

In a recent article in American Shipper, it stated freight will increase 45% by 2035. The current system cannot possibly handle that much additional freight under the current process.

While the Intermodal Network has protocols, rules and even laws to guide its movements, the network groups struggle with each other almost as if mortal enemies, thus creating costly inefficiencies. To those who are skilled in the art of Intermodal, this is clearly evident. Whether it is the view from the Equipment Provider about who is mishandling their equipment, the Motor Carrier complaining of the condition of the equipment he finds at the time of arrival for pick up, or the Railroad who lacks necessary equipment levels because of equipment condition or congested terminals from Motor Carriers backing up, they are all symptomatic of a root problem.

For example, the Federal Motor Carrier Safety Administration, who identified a need for unification, enacted a federal law referred to as “Roadability.” This law was designed to provide direction to, and for, the various Intermodal Groups to follow. In reality, while the intent of the law could have provided that result, its implementation created further inefficiencies and discord for Equipment Providers and Motor Carriers, primarily at Railroad and Marine Terminals.

The problems with the Intermodal Network are the Marine and Rail terminals. The problem with the Marine and Rail terminals are the chassis'. The problem with the chassis is how it is handled. Age & design have some degree of responsibility, but they are not the most critical. Handling is the most critical. At the Intermodal yard, chassis are mishandled and damaged by terminal operators, spotters, lift operators, motor carriers, drivers, company owners and dispatchers, warehousemen, repair vendors, mechanics, steamship lines, equipment owners, and management companies.

This bevy of improper chassis handling negatively impacts equipment owners, the railroads, motor carriers, and citizens of the community at large.

In general, all Intermodal Network participants have an impact on the problem and stand to benefit by correcting the problems through reduced operating expenses, increased productivity and profits.

The Roadability Law was designed with the intent to eliminate substandard chassis condition and for Intermodal Equipment Providers (IEP's) to establish a systematic inspection, repair and maintenance program to create safe chassis' and to address equipment defects identified by the Motor Carrier. While the letter of the law was implemented and is being followed, the combination of the standards change and the elimination of the Railroad's gate inspection personnel, resulting from the transition to an Automatic Gate System (AGS), have magnified the inefficiencies of equipment interchange. The law only references the IEP and the Motor Carrier as having “shared responsibility.” Because of the extreme operating environment that exists on Rail and Marine Terminals, chassis repaired by the IEP usually do not remain at the FMCSA standard for long. Why? Because the law does do hold accountable all entities that handle chassis, in particular, the Terminal Operator.

As such, not only is it in the best interest of terminal operators to handle chassis more efficiently and cause less damage thereto, it is essential in order to mitigate and even neutralize the terminal operators impact on the Intermodal Network.

This new process will eliminate the impact caused by the derelict and unaccountable handling of intermodal chassis by the terminal operator and provide an efficient, robust intermodal network with an opportunity for a mighty financial return on investment. This new process is needed and is the next evolutionary step for the health, viability, growth, and profitability of the intermodal network.

The above references to and descriptions of prior proposals or products are not intended to be, and are not to be construed as, statements or admissions of common general knowledge in the art. In particular, the above prior art discussion does not relate to what is commonly or well known by the person skilled in the art; but assists in the understanding of the inventive step of the present invention of which the identification of pertinent prior art proposals is but one part.

### BRIEF SUMMARY OF THE INVENTION

This invention relates to an efficient and expedited process for managing the throughput of trucks, chassis and freight at intermodal terminals, and minimizing the cost and downtown due to damaged chassis. Specifically, this invention proactively ensures that a chassis is ready for a driver upon his arrival at an intermodal shipping yard which eliminates downtown that customarily occurs when a driver has to address chassis' condition and repairs before leaving an intermodal yard. This invention combines the key attributes of core terminal handling into a unique streamlined design and revamps the terminal operating process. This new terminal flow and optimization principles set forth in this process will increase and maximize the terminal throughput of containerized freight, reduce Terminal Operators handling requirements and significantly increase Motor Carriers' productivity and satisfaction by providing pre-inspected and repaired intermodal equipment and chassis.

One skilled in the art will recognize that the entire process is designed to expedite the Motor Carriers turn-time on terminal by having his unit proactively pre-tripped, repaired, and staged for his pick prior to his arrival.

The process commences with a modified spotter truck, equipped with dual tool and parts boxes on either side, designed to provide an inspector streamlined access to air, tools and parts for each side of the chassis, eliminating the need to walk around the chassis and thus maximizing his productivity. A prime spot in the yard is carved out, referred to as the secured Fastlane. This secured Fastlane is the middle of the yard to allow the most direct path from ingate to outgate.

Mechanics are currently restricted to one small area of the yard and they must drive around that section of the yard to find a designated chassis to repair. This is time-consuming, unproductive and non-revenue generating. Units they fix are spotted to the main yard, placed in racks, placed in a yard stack or to trackside for the next box to be mounted. There is a high likelihood that chassis sustain a defect or are damaged in the extreme operating environments that exist in terminals. In turn, they are in perpetual need of repairs. Each time a driver arrives at a terminal yard, locates his freight, and discovers damage, he is forced to begin the repair process all over again, deciding whether he must go to Roadability, try and fix himself or risk moving chassis in an unsafe condition.

This new inventive process will place inspectors/mechanics in specially designed spotter trucks, ready to receive notice that a load is ready, and will properly inspect the chassis for defects. If the defects are minor, the inspector/mechanic will make those repairs and move set-up to the secured Fastlane and forward notification to Motor Carrier that the load is now ready for pick-up in that location. Motor Carrier arrives and finds that the chassis is ready and departs. As such, a process that used to take an hour now is completed in a matter of minutes by having the chassis ready and keeping his travel within the terminal focused and in the main artery.

Should the chassis require a tire at inspection, the inspector/mechanic will take it to a tire station where a ground technician will swap the tire before it continues to the secured Fastlane for pick up by the Motor Cartier. If the condition of the chassis warrants that the box be flipped to a new chassis, inspector/mechanic again takes the chassis to a delineated repair area where good bare chassis have been staged and the box is flipped and then processed directly to the secured Fastlane for the Motor Carrier. A ground technician will then radio a repair shop that a major repair is waiting for removal at the delineated repair station. In turn, a shop spotter will bring a good order bare chassis to replace the one used and remove the major job to the shop.

This process makes the repair process truly mobile and seeks to capitalize on maximizing repair completion by touching every unit before it departs. Secondly, it promotes safety by ensuring all chassis are FMCSA/DOT roadworthy. Lastly, it provides the mechanism to increase throughput, both for the Railroad and for the Motor Carrier which translates into higher revenues and profitability for each.

It will be appreciated by those skilled in the art that many modifications and variations may be made to the process and methods of the invention described herein without departing from the spirit and scope of the invention.

### BRIEF DESCRIPTION OF THE VIEW(S) OF THE DRAWING(S)

Possible and preferred features of the present invention will now be described with particular reference to an accompanying drawing. However, it is to be understood that the features illustrated in and described with reference to the drawings are not to be construed as limiting on the broad scope of the invention. In the drawing:

FIG. 1 depicts a layout of the claimed process as implemented at a typical intermodal railyard.

FIG. 2 depicts a side view of the modified spotter truck, showing the parts bins that are present on each side of the spotter truck, as well as access portals for air and electric supply.

### DETAILED DESCRIPTION OF THE INVENTION

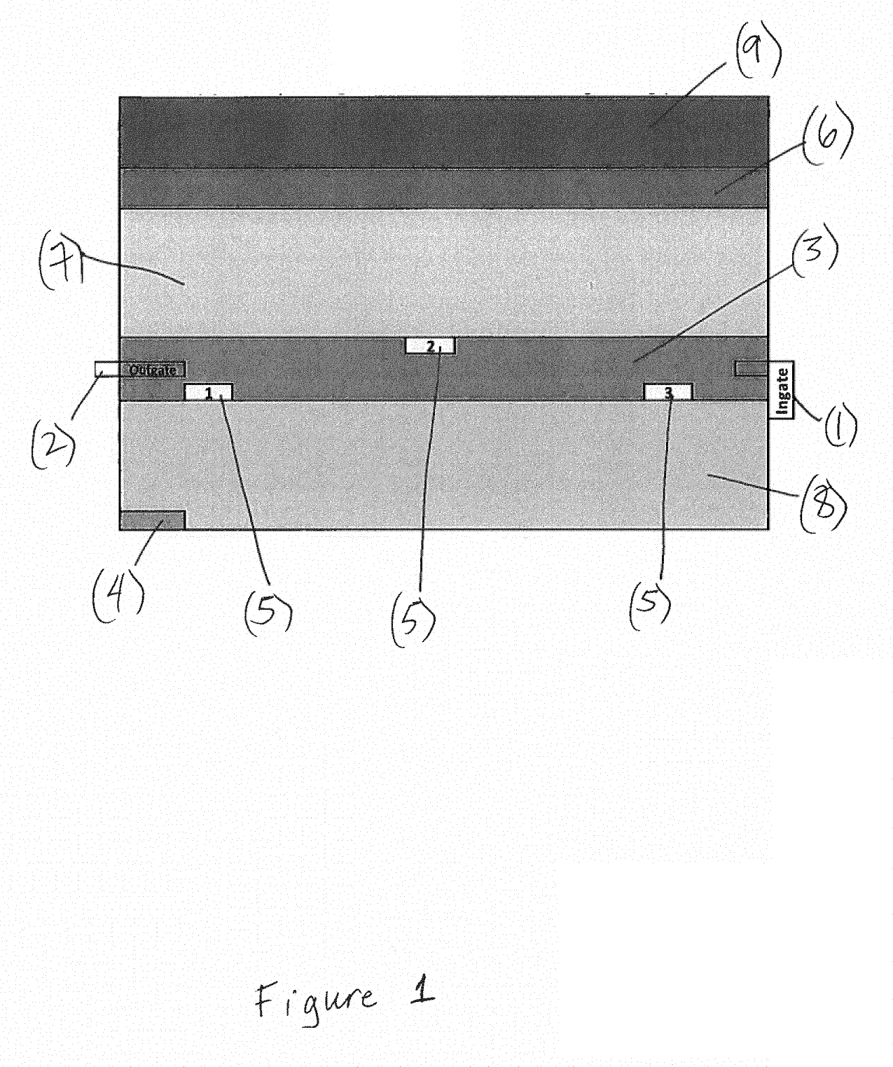

Turning to FIG. 1, what is depicted is an intermodal terminal having one ingate (1), one outgate (2), a secured FastLane (3), which is the main artery through the midline of the yard, a repair shop (4), three tire changing stations/flip areas (5) evenly dispersed throughout the secured FastLane, an area for ground stacks and chassis racks (6), staging location of wheeled imports off the train (7), staging location of wheeled exports off the streets (8), and train tracks along the upper edge of the yard (9).

Motor carriers enter the ingate (1), travel directly to the assigned location of the secured FastLane (2), obtain their cargo, which is ready for pick-up in a fully-repaired, road-ready chassis, and exits the outgate (3). Chassis are readied at the various tire changing and flip area stations dispersed throughout the secured FastLane (5) which enables efficient motor carrier flow through the main artery of the yard.

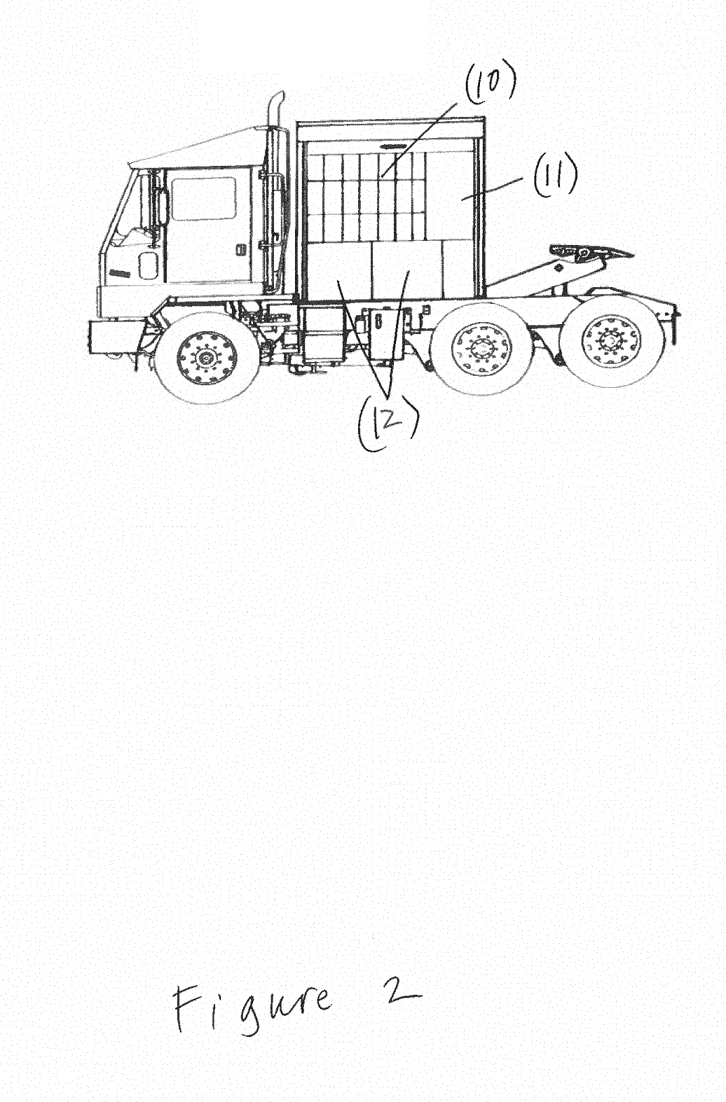

Turning to FIG. 2, what is depicted is the modified spotter truck having parts bins (10), tool boxes (11), and access areas (12) for air and electrical connections on either side.

It will be appreciated that other forms, aspects and preferred features of the invention and its embodiments described herein and those not included may ultimately be included in the claims defining the invention in the specifications of complete, international or national applications which may claim priority from this provisional application.

What is claimed is:

1. A process for streamlined, expedited chassis pick-up at an intermodal yard comprising:
the arrangement of certain readiness stations throughout a secured Fastlane area which is located through the prime, middle, main artery of an intermodal yard, situated between an ingate and an outgate wherein chassis are transported to and from said stations by modified spotters from designated areas for ground stacks & chassis racks, import cargo, export cargo, and a repair shop; and
wherein said chassis are inspected, repaired, and ready to be picked up by motor carriers before said motor carriers arrive at the intermodal yard.

2. the modified spotters of claim 1 further comprising dual tool/parts boxes on either side of the spotter designed to provide access to air, tools, and parts for each side of a chassis.
